(19) United States
(12) Patent Application Publication
(10) Pub. No.: US 2010/0276239 A1
(43) Pub. Date: Nov. 4, 2010

(54) BRAKE SYSTEM AND METHOD FOR OPERATING A BRAKE SYSTEM

(76) Inventors: Gebhard Wuerth, Sulzbach-Laufen (DE); Volker Mehl, Weingarten (DE); Michael Kunz, Steinheim An Der Murr (DE); Matthias Leiblein, Gerlingen (DE); Werner Quirant, Beilstein (DE)

Correspondence Address: KENYON & KENYON LLP, ONE BROADWAY, NEW YORK, NY, 10004, US

(21) Appl. No.: 12/810,595

(22) PCT Filed: Nov. 13, 2008
(86) PCT No.: PCT/EP2008/065439

§ 371 Date: Jun. 25, 2010

(30) Foreign Application Priority Data
Jan. 9, 2008 (DE) 10 2008 003 664.1

(51) Int. Cl. B60T 13/10

(52) U.S. Cl. 188/358

(57) ABSTRACT

A brake system for a vehicle is described, having a main brake cylinder which is designed to detect an actuation of a brake input element and to provide a pressure signal corresponding to the actuation of the brake input element, and a first brake circuit having a first wheel brake cylinder which is configured to exert a force on a first wheel corresponding to the pressure signal, having a first switching valve which is situated between the main brake cylinder and the first wheel brake cylinder and which is designed as an isolating valve, having a first pump and a storage chamber, the storage chamber in a neutral state having a storage volume on a side facing the first pump, and having a first wheel outlet valve which is associated with the first wheel and which is configured to control a flow of braking medium between the first wheel brake cylinder and the storage chamber. A method for controlling a corresponding brake system is also described.

### FIELD OF THE INVENTION

The present invention relates to a brake system for a motor vehicle. The present invention further relates to a method for operating a brake system for a motor vehicle.

### BACKGROUND INFORMATION

In regenerative braking, the vehicle is braked by operating an electric motor as a generator. As a rule, the electric drive motor of the vehicle is operated as a generator. The electrical energy obtained in this manner is stored in a storage system. The stored energy may be subsequently used for accelerating the vehicle. As the result of the regeneration described here, power loss which occurs with a conventional braking process is reduced. It is thus possible to decrease fuel consumption and/or exhaust gas emissions from a vehicle which is braked frequently. A vehicle designed for regenerative braking is often referred to as a hybrid vehicle.

However, the regenerative braking should not influence the braking distance. Therefore, in certain situations the regenerative braking process imposes additional demands on a conventional friction-based brake system of the vehicle. For example, the regenerative brake is not available for a completely electrical energy storage system. In this case the entire braking torque must therefore be applied to the wheels via the conventional brake, i.e., the friction brakes.

In addition, the regenerative braking process requires a specified minimum speed of the vehicle. Exclusive use of the electric motor operated as a generator does not ensure braking torques using which the vehicle may be braked to a stop. If a specified total braking torque is to be held constant until the vehicle has stopped, at low speeds the conventional brake system must compensate for the loss in braking effect of the regenerative brake via a higher braking torque.

However, there is also the situation in which the hydraulic braking force is to be discontinued to achieve the highest possible rate of regeneration. For example, after switching operations, the decoupled generator is to be phased in as a regenerative brake so that the braking effect is shifted in the direction of regenerative braking. This requires that the conventional friction brake be discontinued so that the specified total braking torque is held constant.

Processes in which the braking torque of the conventional friction brake is adapted to the instantaneous braking torque of the regenerative brake to maintain an intended total braking torque are frequently referred to as blending processes. For many vehicles having regenerative braking, the deceleration instruction is given by the driver, who exerts force on the pedal to control the conventional braking torque in such a way that, despite an increase or decrease in the regenerative braking torque, the intended total braking torque is maintained. However, these blending processes entail additional effort for the driver, and therefore detract greatly from the driver's driving comfort.

Furthermore, brake-by-wire brake systems, for example EHB systems, are known in which the blending processes take place completely unnoticed by the driver during deceleration of the vehicle equipped in this manner. However, such a brake-by-wire brake system requires a complicated electronics system and is therefore expensive.

### SUMMARY OF THE INVENTION

The exemplary embodiments and/or exemplary methods of the present invention provides a brake system for a vehicle having the features described herein, and a method for controlling a brake system for a vehicle having the features of claim 10.

The pressure signal refers, for example, to a power relayed, or a pressure transmitted, from the main brake cylinder to the at least one first wheel brake cylinder. With the aid of this relayed power, the first wheel brake cylinder exerts a braking torque on its associated first wheel. The first brake circuit includes at least the first wheel brake cylinder. Of course, the first brake circuit may also have at least one additional wheel brake cylinder which is associated with at least one additional wheel.

The exemplary embodiments and/or exemplary methods of the present invention is based on the finding that for blending a regenerative brake and a conventional friction brake it is advantageous when a first brake circuit of a brake system may be decoupled from the main brake cylinder. In this case the driver no longer directly controls the first brake circuit via the brake pedal and the main brake cylinder. After the first brake circuit is decoupled from the main brake cylinder, it is also advantageous to make use of the option of actuating the at least one first wheel brake cylinder of the first brake circuit in a second manner in which the blending may be taken into account.

The exemplary embodiments and/or exemplary methods of the present invention are also based on the knowledge concerning how to economically implement the possibilities described in the preceding paragraph. For this purpose, a switchover valve which is designed as an isolating valve is situated between the main brake cylinder and the first wheel brake cylinder.

Thus, for carrying out the exemplary embodiments and/or exemplary methods of the present invention it is generally possible to use a component which is already present. This lowers costs and reduces the installation space for the brake system according to the present invention. In addition, a storage chamber may be easily provided in such a way that in a neutral state the storage chamber has a storage volume on a side facing the first pump. With the aid of the at least one wheel inlet valve and/or wheel outlet valve, in the present case a flow of braking medium into the at least one first wheel brake cylinder of the first brake circuit may be controlled in such a way that, upon receipt of a provided control signal, the at least one wheel brake cylinder of the first brake circuit exerts the intended braking torque on the at least one wheel of the first brake circuit.

With the aid of a sensor or by estimation, it is thus possible to ascertain the total braking torque intended by the driver, the instantaneous regenerative braking torque to be exerted by the regenerative brake, and the remaining difference between the intended total braking torque and the instantaneous regenerative braking torque. The braking torque corresponding to the ascertained difference may then be exerted on the first wheel with the aid of the at least one wheel inlet valve and/or wheel outlet valve. This allows blending without the need for additional effort by the driver. Sufficient regeneration efficiency is thus ensured at reasonable cost.

The brake system according to the exemplary embodiments and/or exemplary methods of the present invention may be referred to as a brake-by-wire brake system for only one wheel axle. The rear axle may be operated by wire. This approach represents a convenient and economical option, in particular for rear-wheel or four-wheel drive vehicles. Of course, the front axle may also be operated by wire with the aid of the brake system according to the present invention. The brake system is therefore also well suited for front-wheel drive vehicles.

The exemplary embodiments and/or exemplary methods of the present invention also offers advantages for vehicles having conventional drive and braking trains. For example, the exemplary embodiments and/or exemplary methods of the present invention simplifies a braking force distribution based on lateral acceleration, in which the braking force is distributed to the front wheels and/or rear wheels according to the contact forces which arise while cornering. For example, a lateral acceleration detected by a sensor may be evaluated as an input signal. In this manner the utilized coefficient of friction of the at least two wheels may be compared. This allows more stable braking of the vehicle during cornering.

A further application option for the exemplary embodiments and/or exemplary methods of the present invention is dynamic curve braking, in which the braking force exerted on an inside wheel is increased. This results in a more dynamic driving response.

Likewise, for braking while backing up, a braking force distribution which is better adapted to traveling in reverse may be achieved by increasing the braking force on a wheel axle, which may be the rear wheel axle. This is also referred to as “reverse braking force distribution.” This results in a much more stable driving response, in particular for backing up slowly downhill.

Furthermore, with the aid of the exemplary embodiments and/or exemplary methods of the present invention it is possible to achieve a shorter pedal travel compared to conventional brake systems. This ensures an improved pedal feel, and therefore increased driving comfort for the driver of a vehicle having the brake system according to the present invention.

For example, the first wheel outlet valve may be adjusted to a closed state, an open state, and at least one intermediate state between the closed state and the open state. The wheel outlet valve may in particular be a continuously adjustable valve. This relatively inexpensive specific embodiment of the wheel outlet valve thus ensures actuation of the first wheel brake cylinder for blending of the regenerative braking torque, a braking force distribution based on lateral acceleration, dynamic curve braking, and/or an increase in the braking force at the rear axle.

In one refinement the brake system includes a second brake circuit having a second wheel brake cylinder, situated on a second wheel, which is coupled to the main brake cylinder in such a way that the pressure signal may be transmitted from the main brake cylinder to the second wheel brake cylinder, and which is designed to exert a force on the second wheel which corresponds to the pressure signal. The brake system according to the present invention may thus have at least two brake circuits. Of course, the second brake circuit may also have at least one additional wheel.

The second brake circuit may have a second switchover valve with a bypass line, situated parallel to the second switchover valve, which has a check valve. The hydraulic connection between the main brake cylinder and the second wheel brake cylinder is thus protected from failure or blockage of the second switchover valve.

In particular, the second brake circuit may have a second pump, which together with the first pump of the first brake circuit is situated on a shaft, the first and second pumps being drivable via a motor. In this manner a second motor which would require additional installation space within the brake system may be spared.

In one refinement the motor may be operated in a first rotational direction and in a second rotational direction, a first coupling element situated between the motor and the first pump being designed in such a way that the first pump is driven when the motor is operated in the first and in the second rotational directions, and a second coupling element situated between the motor and the second pump being designed in such a way that the second pump is driven when the motor is operated in the first rotational direction, and is decoupled from the motor when the motor is operated in the second rotational direction. In this manner, forced simultaneous operation of the second pump when the first pump is driven by the motor may be prevented.

In a further refinement, the second brake circuit may be switched to a first state and to a second state, which are designed in such a way that driving the second pump of the second brake circuit switched to the first state causes a change in pressure at the second wheel brake cylinder, and driving the second pump of the second brake circuit switched to the first state causes a circulating flow of the braking medium in the second brake circuit. This may be achieved, for example, by the fact that the second brake circuit has a check valve situated between the second switchover valve and the second pump, and has a valve situated parallel to the second pump, the second brake circuit being switchable to the first state by closing the valve, and being switchable to the second state by opening the valve. This ensures a further option for preventing undesired simultaneous operation of the second pump when the first pump is driven by the motor.

The advantages described above are also ensured by using a corresponding method.

Further features and advantages of the exemplary embodiments and/or exemplary methods of the present invention are explained below with reference to the figures.

### BRIEF DESCRIPTION OF THE DRAWINGS

FIG. 1 shows a circuit diagram of a first specific embodiment of the brake system.

FIG. 2 shows a circuit diagram of a second specific embodiment of the brake system.

FIG. 3 shows a circuit diagram of a third specific embodiment of the brake system.

### DETAILED DESCRIPTION

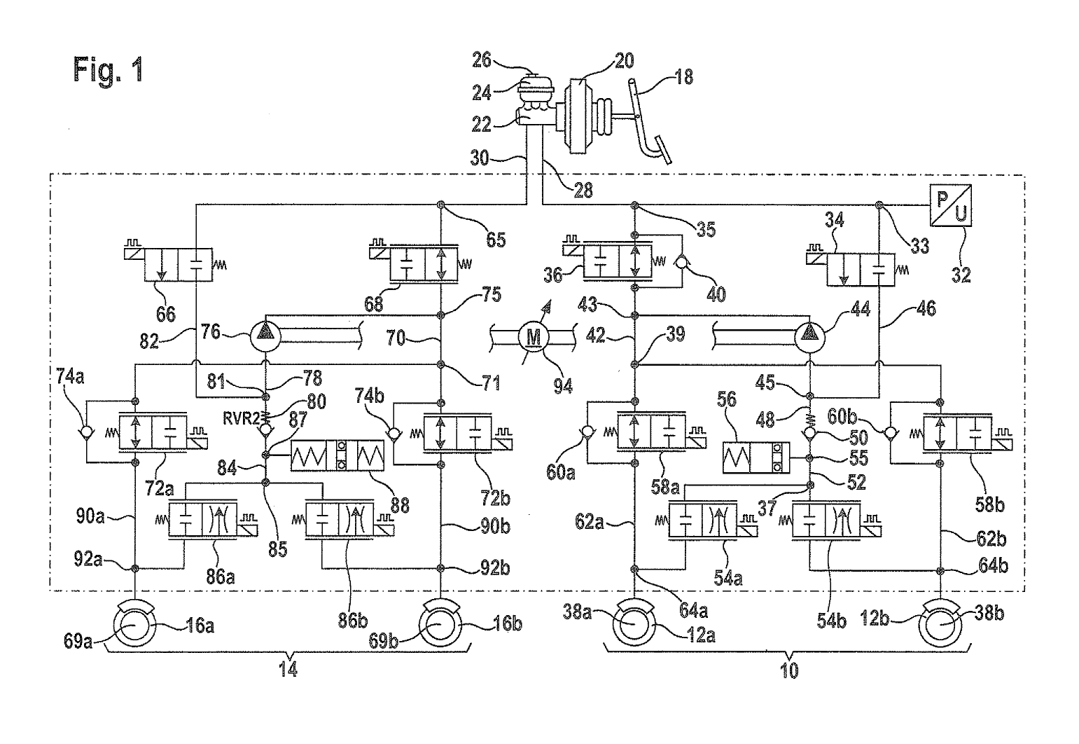

FIG. 1 shows a circuit diagram of a first specific embodiment of the brake system.

The brake system illustrated in FIG. 1 is designed as a dual-piston system, for example. The brake system includes a front brake circuit 10 for braking front wheels 12a and 12b, and a rear brake circuit 14 for braking rear wheels 16a and 16b. However, the illustrated example is not limited to this division of wheels 12a, 12b, 16a, and 16b. Of course, the example may also be applied to a specific embodiment in which wheels 12a and 12b are the rear wheels and wheels 16a and 16b are the front wheels of a vehicle. Wheels 12a and 12b and wheels 16a and 16b may also be two pairs of wheels which are situated on two different sides of a vehicle or situated diagonally on a vehicle.

At this point it is expressly noted that the brake system illustrated in FIG. 1 is not limited to the fixed number of four wheels 12a, 12b, 16a, and 16b. Rather, the brake system may be expanded in such a way that it controls a greater number of wheels. For example, the brake system then has at least two brake circuits which correspond to front brake circuit 10.

Likewise, the brake system may be used not only for hybrid vehicles, but also for any known type of motor vehicle. As described below, when driving a vehicle which is not designed as a hybrid vehicle, vehicle situations also result in which use of the brake system according to the present invention is advantageous.

The brake system has a brake pedal 18 as actuating element. Brake pedal 18 may have a pedal travel sensor, a booster diaphragm displacement sensor, or a rod displacement sensor for ascertaining an actuation performed on brake pedal 18. However, the illustrated brake system is not limited to brake pedal 18 for inputting a braking intention of a driver. Instead, a braking intention of a driver may also be detected using other sensor elements, which are appropriately connected to the front and/or rear brake circuit 10 and 14, respectively.

Brake pedal 18 is coupled to main brake cylinder 22 via a brake booster 20. Main brake cylinder 22 is connected to a braking medium reservoir 24 which may be filled via a filler nozzle 26. For example, the braking medium reservoir 24 is a container for hydraulic fluid and/or brake fluid.

From main brake cylinder 22 a first feed line 28 leads to front brake circuit 10, and a second feed line 30 leads to rear brake circuit 14. A pressure sensor 32 may be connected to first feed line 28. Also connected to feed line 28 are a high-pressure switching valve 34 via a branch point 33 and a switchover valve 36 via a branch point 35. Brake fluid originating from main brake cylinder 22 may optionally flow in front brake circuit 10 via high-pressure switching valve 34 and a pump 44, or via switchover valve 36 in the direction of wheel brake cylinders 38a and 38b of wheels 12a and 12b, respectively.

A bypass line having a check valve 40 is situated parallel to switchover valve 36. In the event of malfunction of switchover valve 36, the hydraulic connection between main brake cylinder 22 and wheel brake cylinders 38a and 38b, which otherwise would be interrupted due to the malfunction, is ensured by the bypass line having check valve 40. Thus, even in the event of failure and/or complete blockage of switchover valve 36, braking of wheels 12a and 12b controlled by brake pedal 18 is possible.

Connected to switchover valve 36 is a line 42 which has a branch point 43 which leads to a delivery side of a first pump 44. Pump 44 may be a single-piston pump or a similarly designed displacement element. However, first pump 44 may also be a pump having multiple pistons, or may be a gear pump.

A line 46 leading away from high-pressure switching valve 34 via a branch point 45 is connected to a line 48 which leads from the suction side of pump 44 to a check valve 50. A line 52 extends from check valve 50 to a wheel outlet valve 54b associated with wheel brake cylinder 38b. A wheel outlet valve 54a associated with wheel brake cylinder 38a via a branch point 37 is likewise connected to line 52. In addition, a storage chamber 56 is also connected to line 52 via a branch point 55.

Line 42 leads from switchover valve 36 to a wheel inlet valve 58a associated with wheel brake cylinder 38a. A wheel inlet valve 58b associated with wheel brake cylinder 38b is likewise connected to line 42 via a branch point 39. Bypass lines having check valves 60a and 60b are situated parallel to wheel inlet valves 58a and 58b, respectively.

Wheel inlet valve 58a and wheel brake cylinder 38a are connected to one another via a line 62a. Wheel outlet valve 54a is connected to line 62a via a branch point 64a. Similarly, wheel outlet valve 54b is also connected via a branch point 64b to a line 62b situated between wheel inlet valve 58b and wheel brake cylinder 38b.

Valves 34, 36, 54a, 54b, 58a, and 58b of front brake circuit 10 may be designed as hydraulic valves. Switchover valve 36 and wheel inlet valves 58a and 58b may be configured as normally open valves, and high-pressure switching valve 34 and wheel outlet valves 54a and 54b may be configured as normally closed valves. A pressure buildup in wheel brake cylinders 38a and 38b of the brake calipers, requested by the driver, is thus reliably ensured in normal braking operation of brake system 10. Similarly, the built-up pressure in wheel brake cylinders 38a and 38b of the brake calipers may also be quickly reduced.

Feed line 30 likewise connects a high-pressure switching valve 66 and a switchover valve 68 (via a branch point 65) to main brake cylinder 22. In contrast to switchover valve 36 of front brake circuit 10, switchover valve 68 of rear brake circuit 14 is designed as an isolating valve. A bypass line having a check valve is not provided on switchover valve 68. Closing switchover valve 68 thus causes decoupling of rear brake circuit 14, in particular of wheel brake cylinders 69a and 69b of wheels 16a and 16b, respectively, from main brake cylinder 22.

A line 70 extends from switchover valve 68 to a wheel inlet valve 72b associated with wheel brake cylinder 69b. A wheel inlet valve 72a associated with wheel brake cylinder 69a is likewise connected to line 70 via a branch point 71. Bypass lines having check valves 74a and 74b are situated parallel to wheel inlet valves 72a and 72b, respectively. In addition, a delivery side of pump 76 is connected to line 70 via a branch point 75. Pump 76 may be designed as a single-piston pump, a pump having multiple pistons, or a gear pump.

A check valve 80 is connected to the suction side of pump 76 via a line 78. A line 82 to high-pressure switching valve 66 extends from a branch point 81 of line 78 situated between pump 76 and check valve 80. A line 84 to a branch point 85 to which wheel outlet valves 86a and 86b are connected extends on a side of check valve 80 facing away from line 78.

Wheel outlet valves 86a and 86b may each be switched to a closed state, an open state, and at least one intermediate state between the closed state and the open state. In the intermediate state, wheel outlet valve 86a or 86b is only partially open. Wheel outlet valves 86a and 86b may be configured as continuously actuatable wheel outlet valves. On the other hand, for wheel outlet valves 54a and 54b of front brake circuit 10, less expensive wheel outlet valves may be used which may be switched only to an open and to a closed state.

A storage chamber 88 is connected to line 84 via a branch point 87. In a neutral state, storage chamber 88 has a storage volume on a side facing pump 76. The storage volume may be a brake fluid storage volume. Thus, in its neutral state, i.e., in the pressure-balanced state of rear brake circuit 14, storage chamber 88 provides a volume. Storage chamber 88 may have a storage displacement sensor and/or a storage limit switch to reliably set the volume in storage chamber 88 and to correspondingly operate storage chamber 88. This is also referred to as a volume estimation or volume management. In contrast, storage chamber 56 may be economically selected in such a way that it provides no volume in the pressure-balanced state of front brake circuit 10.

Wheel inlet valves 72a and 72b are respectively connected to one of wheel brake cylinders 69a and 69b of wheels 16a or 16b via lines 90a and 90b. Wheel outlet valve 86a is connected to line 90a via a branch point 92a. Similarly, wheel outlet valve 86b is connected to line 90b via a branch point 92b.

Valves 66, 68, 72a, 72b, 86a, and 86b may also be hydraulic valves. In one specific embodiment, switchover valve 68 and wheel inlet valves 72a and 72b are normally open valves. In this case, high-pressure switching valve 66 and wheel outlet valves 86a and 86b are advantageously designed as normally closed valves.

The two pumps 44 and 76 are situated on a common shaft which is operated via a motor 94. In one economical specific embodiment, motor 94 may be designed to rotate in only one rotational direction.

In summary, it is noted that rear brake circuit 14 having the two wheel brake cylinders 69a and 69b may be easily decoupled from main brake cylinder 22 due to the design of switchover valve 68 as an isolating valve. Engagement of main brake cylinder 22 with wheel brake cylinders 69a and 69b is no longer possible when switchover valve 68 is closed. On the other hand, when switchover valve 68 is open, engagement with wheel brake cylinders 69a and 69b is possible, corresponding to a conventional modulation system.

Storage chamber 88 is designed in such a way that it allows reliable filling and/or emptying of wheel brake cylinders 69a and 69b of wheels 16a and 16b, respectively. Filling wheel brake cylinders 69a and 69b with a brake fluid from storage chamber 88 is possible in particular in a situation in which wheel brake cylinders 69a and 69b are decoupled from brake cylinder 22 with the aid of switchover valve 68. Subsequent emptying of wheel brake cylinders 69a and 69b with the aid of storage chamber 88 is also similarly possible.

Wheel outlet valves 86a and 86b are designed in such a way that a pressure present at wheel brake cylinders 69a and 69b may be controlled by wheel outlet valves 86a and 86b, even after wheel brake cylinders 69a and 69b are decoupled from main brake cylinder 22. For this purpose, wheel outlet valves 86a and 86b are designed in such a way that they may be set in a closed, open, or at least one partially open state.

An exemplary procedure for operating rear brake circuit 14 is described below:

In a system state in which neither brake pedal 18 nor any other brake actuating element is actuated for inputting a braking intention, all valves 34, 40, 54a, 54b, 58a, 58b, 66, 68, 72a, 72b, 86a, and 86b are currentless. Thus, a hydraulic connection is present between main brake cylinder 22 and rear brake circuit 14, i.e., between the two wheel brake cylinders 69a and 69b. A connection is also present between front brake circuit 10 and the front wheel brake calipers.

If the driver applies light pressure to brake pedal 18, a control device (not illustrated) provides power to switchover valve 68, and switchover valve 68 is closed. In this partial braking, main brake cylinder 22 is decoupled from wheel brake cylinders 69a and 69b of rear wheels 16a and 16b, respectively. Thus, via brake pedal 18 the driver performs braking only in front brake circuit 10.

At the same time, the driver's braking intention is detected with the aid of a sensor system (not illustrated) and is evaluated with regard to an intended total braking torque. In addition, the instantaneous brake pressure present at wheels 12a and 12b is ascertained. An evaluation device then computes the brake pressure difference between the intended total braking torque and the brake pressure which is present at wheels 12a and 12b. Pump 76 is then actuated in such a way that a volume corresponding to the brake pressure difference is transferred from the expanded volume of storage chamber 88 to wheel brake cylinder 69a and 69b of wheels 16a and 16b, respectively. For subsequent discontinuation of braking, the volume is discharged into storage chamber 88 from respective wheel brake cylinders 69a and 69b of wheels 16a and 16b via wheel outlet valves 86a and 86b.

As an example, the manner in which the brake system illustrated in FIG. 1 may be used for regenerative braking is described below. For this purpose, rear brake circuit 14 is connected to an electric motor which functions as a generator during the regenerative braking. Thus, during the regenerative braking, a nonconstant but known braking torque of the generator acts on wheels 16a and 16b.

The total braking torque intended by the driver may be ascertained with the aid of a suitable sensor system on brake pedal 18. The braking torques exerted on wheels 12a and 12b by the conventional friction brake and on wheels 16a and 16b by the regenerative brake may likewise be ascertained. The evaluation device is then able to compute the braking torque difference between the total braking torque intended by the driver and the braking torques present at wheels 12a, 12b, 16a, and 16b. This braking torque difference is then set on wheels 16a and 16b according to the procedure described above. The blending process described here is hardly perceived by the driver, and therefore also does not adversely affect driving comfort.

The generator for the regenerative brake is typically situated on the “by wire” axle of the vehicle. However, the specific embodiment described here may also be applied to a brake system in which the regenerative brake exerts a braking torque on a wheel which is not associated with the “by wire” brake circuit.

In one specific embodiment the brake pressure may be set at the rear axle with the aid of high-pressure switching valve 66. Alternatively, the brake pressure may be regulated at the rear axle. For this purpose, at least one pressure sensor is situated in the region of at least one of wheels 16a or 16b and/or in the vicinity of the rear axle.

In one refinement of the brake system, a control device for the brake system may be designed in such a way that, for highly dynamic braking of the vehicle, switchover valve 68 of rear brake circuit 14 is intentionally kept open. In this manner a volume may be shifted from main brake cylinder 22 into wheel brake cylinders 69a and 69b of wheels 16a and 16b, respectively, using dynamics specified by the driver. In this case, the pressure buildup dynamics at wheels 16a and 16b are no longer a function of the hydraulic functioning of pump 76. The braking dynamics are therefore comparable to those of a conventional brake system. This ensures a quick response to a sudden braking intention of a driver.

Similarly as for the above-described example for a regenerative brake, with the aid of the described method and the illustrated brake system it is also possible to achieve a braking force distribution based on lateral acceleration, dynamic curve braking, or reverse braking force distribution.

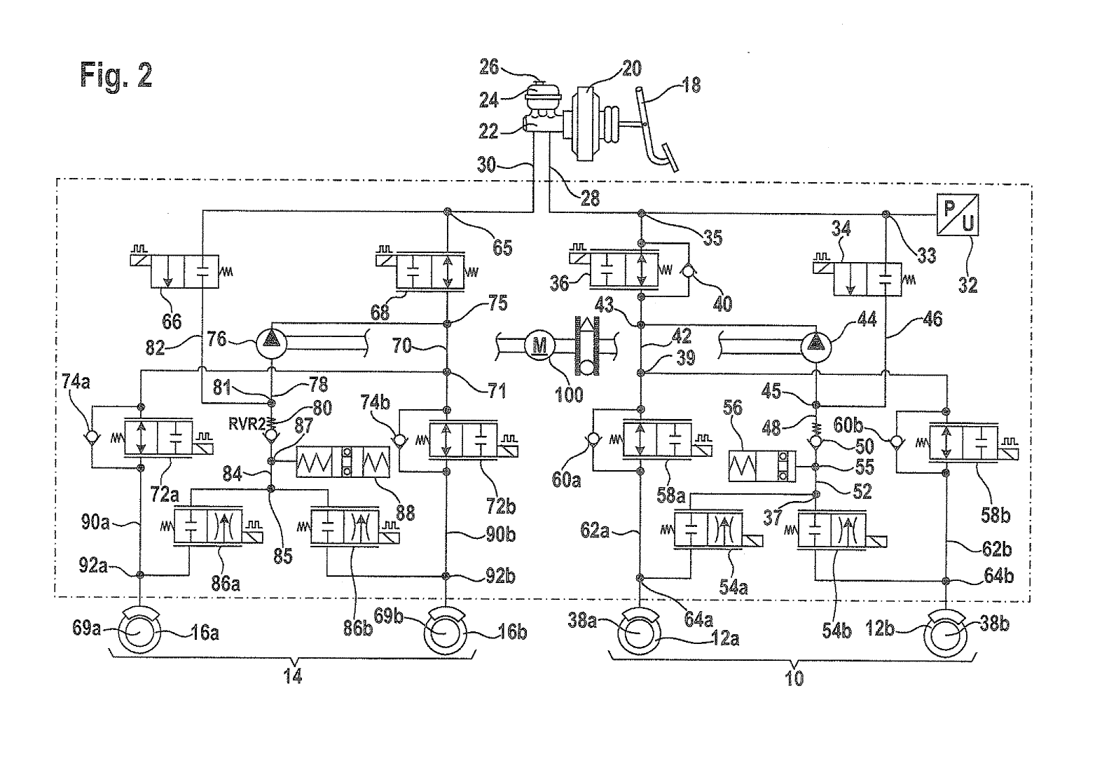

FIG. 2 shows a circuit diagram of a second specific embodiment of the brake system.

The brake system illustrated in FIG. 2 has previously described components 10 through 92 of the brake system explained with reference to FIG. 1. In contrast to the brake system of FIG. 1, the brake system of FIG. 2 includes a motor 100 which is able to rotate in two opposite rotational directions. The motor path of motor 100 is thus designed in such a way that motor 100 is able to operate in forward and reverse modes.

In addition, pump 44 is coupled to motor 100 in such a way that a one-way clutch is provided between pump 44 and motor 100. The one-way clutch disengages when motor 100 rotates in its first rotational direction.

In a situation in which a brake pressure is to be built up only on wheels 16a and 16b, motor 100 is operated in its first rotational direction, which may be in reverse mode. In this case the one-way clutch situated between pump 44 and motor 100 disengages, and pump 44 is decoupled from motor 100. Thus, during operation of motor 100 in its first rotational direction only pump 76 of rear brake circuit 14 is driven by motor 100. Pump 44, meanwhile, is inactive. The actuation of motor 100 in its first rotational direction therefore influences only the brake pressure present at wheels 16a and 16b.

Forced simultaneous operation of pump 44 during a pressure buildup at wheels 16a and 16b may thus be avoided. This is advantageous when no volume delivery is necessary to wheels 12a and 12b. In this manner, impairment of driving comfort as the result of pedal pulsations, which are typically associated with forced simultaneous operation of pump 44 of front brake circuit 10, is avoided. This improves the driver's driving comfort.

If simultaneous actuation of both pumps 44 and 76 is intended, motor 100 is operated in its second rotational direction, which may be in forward mode. The second rotational direction of motor 100 is the blocking direction of the one-way clutch. The two pumps 44 and 76 situated on a common shaft are thus driven by motor 100 at the same rotational speed. In the event of a delivery request in both brake circuits 10 and 14, a pressure buildup and/or an ABS regulation in both brake circuits 10 and 14 is thus possible.

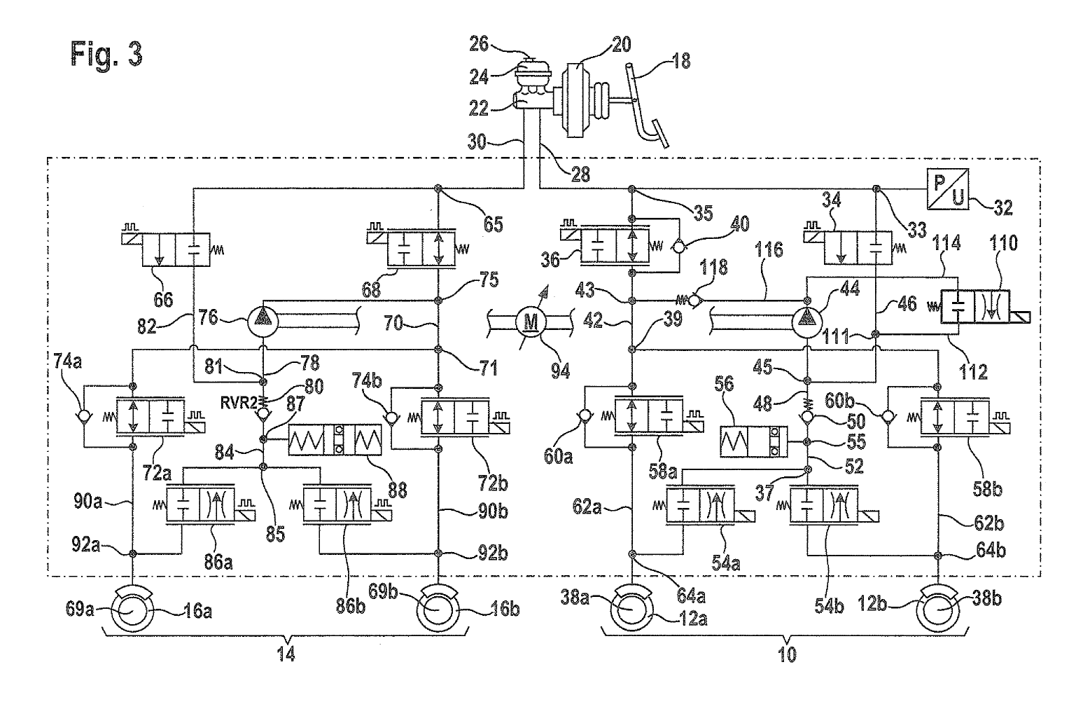

FIG. 3 shows a circuit diagram of a third specific embodiment of the brake system.

The brake system illustrated in FIG. 3 has previously described components 10 through 94 of the brake system of FIG. 1. In addition to the brake system of FIG. 1, front brake circuit 10 of the brake system in FIG. 3 has an additional valve 110 which is connected to line 46 via a line 112 and a branch point 111. In addition, valve 110 is connected to an input of pump 44 via a line 114 and branch point 45. Valve 110 may be configured as a normally closed valve. The brake system of FIG. 3 also has a check valve 118 in a line 116 which extends from branch point 43 of line 42 to pump 44.

If a pressure buildup is intended only at wheel brake cylinders 69a and 69b of rear brake circuit 14, valve 110 may be opened. In this case, during operation of motor 94, pump 44 of front brake circuit 10 is operated at the same rotational speed as pump 76 of rear brake circuit 14, but due to the opening of valve 110 operates only in circulation mode. Front brake circuit 10 is thus switched to a state in which operation of pump 44 causes only a circulating flow of the brake fluid in front brake circuit 10. Therefore, a pressure buildup does not occur at wheel brake cylinders 69a and 69b of rear brake circuit 14. Despite the forced simultaneous actuation of pump 44, pedal pulsations resulting from opening of valve 110 may be minimized or prevented. Thus, the driving comfort of the driver is not adversely affected as a result of the simultaneous actuation of pump 44.

However, if simultaneous operation of pump 44 together with pump 76 is intended, valve 110 is not actuated and remains closed. After valve 110 is closed, operation of pump 44 results in a buildup of brake pressure at all wheels 12a, 12b, 16a, and 16b. A dual-circuit pressure buildup and/or ABS regulation is thus possible.

1-10. (canceled)

11. A brake system for a vehicle, comprising:
a main brake cylinder, which is configured to detect an actuation of a brake input element and to provide a pressure signal corresponding to the actuation of the brake input element; and
a first brake circuit, including:
at least one first wheel brake cylinder, which is situated on a first wheel and which is coupled to the main brake cylinder so that the pressure signal may be transmitted from the main brake cylinder to the first wheel brake cylinder, and which is configured to exert a force on the first wheel corresponding to the pressure signal;
a first switchover valve, which is situated between the main brake cylinder and the first wheel brake cylinder and which as an isolating valve is configured to prevent the pressure signal from being transmitted to the first wheel brake cylinder when a provided closing signal is received;
a first pump;
a storage chamber, the storage chamber in a neutral state having a storage volume on a side facing the first pump; and,
a first wheel outlet valve which is associated with the first wheel and which is configured to control a flow of braking medium between the first wheel brake cylinder and the storage chamber.

12. The brake system of claim 11, wherein the first wheel outlet valve may be adjusted to a closed state, an open state, and at least one intermediate state between the closed state and the open state.

13. The brake system of claim 12, wherein the wheel outlet valve is a continuously adjustable valve.

14. The brake system of claim 11, wherein the brake system includes a second brake circuit having a second wheel brake cylinder, situated on a second wheel, which is coupled to the main brake cylinder so that the pressure signal may be transmitted from the main brake cylinder to the second wheel brake cylinder, and which is configured to exert a force on the second wheel, which corresponds to the pressure signal.

15. The brake system of claim 14, wherein the second brake circuit has a second switchover valve with a bypass line, which is situated parallel to the second switchover valve and has a check valve.

16. The brake system of claim 14, wherein the second brake circuit has a second pump, which together with the first pump of the first brake circuit is situated on a shaft, the first pump and the second pump being drivable via a motor.

17. The brake system of claim 16, wherein the motor may be operated in a first rotational direction and in a second rotational direction, a first coupling element situated between the motor and the first pump being configured so that the first pump is driven when the motor is operated in the first and in the second rotational directions, and a second coupling element situated between the motor and the second pump being configured so that the second pump is driven when the motor is operated in the first rotational direction, and is decoupled from the motor when the motor is operated in the second rotational direction.

18. The brake system of claim 16, wherein the second brake circuit is switchable to a first state and to a second state, which are configured so that driving the second pump of the second brake circuit switched to the first state causes a change in pressure at the second wheel brake cylinder, and driving the second pump of the second brake circuit switched to the second state causes a circulating flow of the braking medium in the second brake circuit.

19. The brake system of claim 18, wherein the second brake circuit has a check valve situated between the second switchover valve and the second pump, and has a valve situated parallel to the second pump, the second brake circuit being switchable to the first state by closing the valve, and being switchable to the second state by opening the valve.

20. A method for controlling a brake system for a vehicle, the method comprising:
receiving a provided closing signal and closing a first switchover valve to prevent a pressure signal from being transmitted from a main brake cylinder to a first wheel brake cylinder;
receiving a provided control signal for a brake pressure to be applied to a first wheel; and
controlling a flow of brake fluid between the first wheel brake cylinder and a storage chamber for adjusting the brake pressure at the first wheel;
wherein a main brake cylinder is configured to detect an actuation of a brake input element and to provide a pressure signal corresponding to the actuation of the brake input element, and having a first brake circuit having at least one first wheel brake cylinder which is situated on the first wheel and which is coupled to the main brake cylinder so that the pressure signal may be transmitted from the main brake cylinder to the first wheel brake cylinder, and which is configured to exert a force on the first wheel corresponding to the pressure signal, having a first switchover valve which is situated between the main brake cylinder and the first wheel brake cylinder and which is configured as an isolating valve, having a first pump and the storage chamber, the storage chamber in a neutral state having a storage volume on a side facing the first pump, and having a first wheel outlet valve which is associated with the first wheel.

21. The method of claim 20, wherein the method is used for at least one of a recuperative braking, a lateral acceleration-dependent braking force distribution, a dynamic curve braking, and a reverse braking force distribution.

22. A brake system for a vehicle, comprising:
a main brake cylinder configured to detect an operation of a brake input element and to provide a pressure signal that corresponds to the operation of the brake input element; and
a first brake circuit, including:
at least one first wheel brake cylinder situated on a first wheel, which is coupled to the main brake cylinder so that the pressure signal is able to be transmitted on from the main brake cylinder to the first wheel brake cylinder, and which is configured to exert a force corresponding to the pressure signal on the first wheel;
a first switchover valve situated between the main brake cylinder and the first transmitting on of the pressure signal to the first wheel brake cylinder upon a reception of a provided closing signal;
a storage chamber;
a first pump, wherein in a neutral state the storage chamber has a storage volume on a side facing the first pump; and
a wheel outlet valve associated with the first wheel, which is configured to control a braking medium flow between the first wheel brake cylinder and the storage chamber; and
a second brake circuit, including a second wheel brake cylinder situated on a second wheel, which is coupled to the main brake cylinder, wherein a braking torque difference between a total braking torque intended by the driver and the braking torques exerted using a friction brake on the wheels of the second brake circuit and exerted on the wheels of the first braking circuit using a recuperative brake being calculated using an evaluating device and the braking torque difference is set at the wheels of the first braking circuit using the first pump.
